(19) United States
(12) Patent Application Publication
(10) Pub. No.: US 2006/0216995 A1
(43) Pub. Date: Sep. 28, 2006

(54) Electric connector receptacle with lock nut

(76) Inventors: Yasuo Ohki, Tokyo (JP); Yasuo Omori, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/378,301

(22) Filed: Mar. 20, 2006

(30) Foreign Application Priority Data
Mar. 23, 2005 (JP) 2005-083596

(51) Int. Cl. H01R 13/648

(52) U.S. Cl. 439/607

(57) ABSTRACT

To provide an electric connector receptade with lock nut having a simple connector housing structure, a secure earth course of a metal shell to ground, and excellent durability, it indudes a connector housing having a pair of locking sections formed nut-storing-sections therein, nuts for locking by fitting-in stored in the nut-storing-sections, and a metal shell covering the connector housing. The nut-storing-section is opened at an upper side, and formed in a vertically elongated, concave shape with a depth to receive the nut fully, and has a screw-insertion-hole running through the locking section across the nut-storing-section, and a shell-strip through-hole running through the locking section above the screw-insertion-hole. A retaining through-strip is formed in the shell, which is inserted into the shell-strip through-hole and contacted to an upper part of the nut stored in the nut-storing-section, thereby prevents falling-off of the nut, and electrically conducts to the nut.

### BACKGROUND OF THE INVENTION

1. Field of the Invention

The present invention relates to an electric connector receptacle with lock nut in which a connection condition is firmly kept by screw fastening.

2. Related Art

As an electric connecter receptacle having a metal shell for a measure against EMI used for connection of a personal computer, LAN device, measuring instrument and the like, for example, an electric connecter receptacle has been known, wherein the metal shell is electrically connected to a conductive nut fitted in a through-hole of a connector body and a metal sheet member by using screws, and when the receptacle is mounted on a printed circuit board, the shell is earthed to a conductive portion of the relevant printed circuit board (refer to JP-U-5-72069).

However, in such a conventional electric connector receptacle, the conductive nut is fitted in the through-hole of the connector receptacle body, and the metal shell is fixed by the screws and thus electrically conducted to the nut, that is, since screws and nuts are used for structures for fixing the metal shell and fixing the connector to the printed circuit board, a nut-storing-structure of the connector body becomes complicated, and the number of components is increased, in addition, the number of fixation operations is increased, consequently much time is required. Moreover, since a condition of connection to an electric connector plug as the other connector is made only by fitting-in of a connection port, and the screw and the nut for securely and firmly holding the connection condition are not used for locking, connection performance is inferior in reliability.

### SUMMARY OF THE INVENTION

It is an object to solve such problems in the conventional art and provide an electric connector receptacle with lock nut that is simple in structure and securely earthed.

Thus, an electric connector receptacle with lock nut according to the invention is configured to include a connector housing having a pair of locking sections in which nut-storing-sections are formed, nuts for locking by fitting-in stored in the nut-storing-sections, and a metal shell that covers part of an outer surface of the connector housing; wherein the nut-storing-section is opened at an upper side, and formed in a vertically elongated, concave shape with a depth at which the nut is fully received, and has a screw-insertior-hole running through the locking section in a back and forth direction across the nut-storing-section, and a shell-strip through-hole running through the locking section above the screw-insertion-hole and in the back-and-forth direction across the nut-storing-section, and a retaining through-strip is formed in the shell, which is inserted into the shell-strip through-hole and contacted to an upper part of the nut stored in the nut-storing-section, thereby prevents falling-off of the nut, in addition, electrically conducts to the nut.

Preferably, a latching strip is extendedly provided at a front end of the retaining through-strip, which runs through the shell-strip through-hole and is bent in a vertical direction to fix the shell to the connector housing. Moreover, a projection for pressing the nut is preferably formed on a bottom side of the retaining through-strip.

According to the electric connector receptacle with lock nut of the invention, the nut stored in the nut-storing-portion of the connector housing is contacted to the retaining through-strip as a part of the metal shell, thereby the nut is electrically conducted to the shell and retained, in addition, when the nut is screw-damped by a screw of a connector plug as the other connector, a metal shell of the connector plug as the other connector is also electrically conducted via the screw and thus earthed to ground (conductive portion) of a printed circuit board. Thus, the nut is retained by attaching the metal shell to the connector housing, in addition, since only this kind of nut for retaining the screw is used, a housing configuration of the nut-storing-section can be made in a simple structure. Moreover, since earth to the ground is made using the screw and the nut, the earth is securely made, and a condition of the earth is excellent in durability.

Moreover, since the latching strip for fixing the shell, which runs through the shell-strip through-hole and is bent in the vertical direction, is formed at the front end of the retaining through-strip, when the metal shell is attached to the connector housing, the latching strip is inserted into the shell-strip through-hole, and the strip which is protruded from the hole is bent upward or downward, and only by this, operation of fixing the shell to the relevant connector housing is easily assisted, in addition, an electrical conducting structure is simplified.

Furthermore, the projection for pressing the nut is formed on the bottom side of the retaining through-strip, thereby the nut stored in the nut-storing-section is fixed in a stable condition without rattling, and an electrical conducting condition between the metal shell and the nut becomes stable.

### BRIEF DESCRIPTION OF THE DRAWINGS

FIGS. 1A, 1B and 1C are front, right side and back views showing respectively an electric connector receptade with lock nut according to an embodiment of the invention;

FIGS. 2A, 2B, 2C, 2D and 2E are front, plane, bottom, right side and back views showing respectively a connector housing of the electric connector receptacle with lock nut;

FIGS. 3A, 3B, 3C, 3D and 3E are front, plane, bottom, right side and back views showing respectively a metal shell of the electric connector receptade with lock nut;

FIGS. 4A, 4B and 4C are vertical section views seen from a lateral side, showing respectively use situations of a nut and a retaining through-strip in a locking section of the connector housing;

FIGS. 5A and 5B are plane and right side views showing respectively a use situation of the electric connector receptade with lock nut; and

FIG. 6 is a vertical section view showing a use situation of the electric connector receptade with lock nut in a partially enlarged manner.

### DETAILED DESCRIPTION OF THE PREFERRED EMBODIMENTS

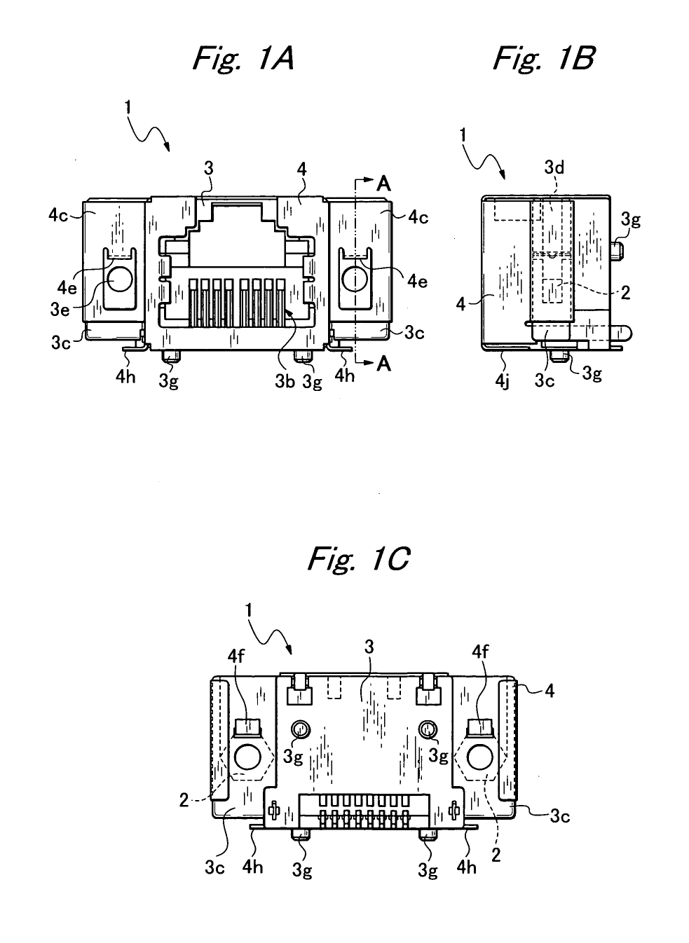

An electric connector receptade with lock nut 1 according to an embodiment of the invention is applied, for example, to a plug-in phone connector for network used for internet connection in the personal computer, LAN device and the like, and as shown in FIG. 1A to FIG. 1C, it has a synthetic-resin connector housing 3 integrally having a pair of locking sections 3c, 3c on either side, and a metal shell 4 that covers part of an outer surface of the connector housing 3 as a measure against EMI. A nut-storing-section 3d is formed in the locking section 3c, and a nut 2 for fixation by fitting-in is stored in the nut-storing-section 3d.

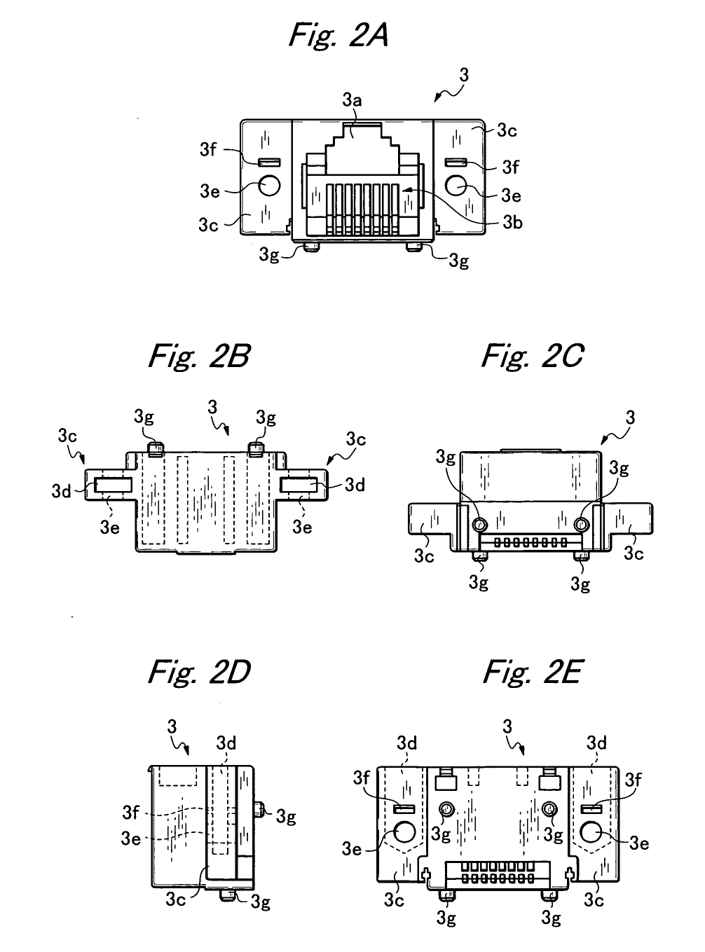

In the connector housing 3, as shown in FIG. 2A, a fitting-in space 3a in which a modular jack is inserted and fitted is formed largely in a front and central portion, and a plurality of contacts 3b extending upward from the lower side of the housing are provided. On either lateral side of the connector housing 3, the locking section 3C is integrally provided in a protrusive manner. The locking section 3C is protruded with a certain width from a slightly back position with respect to the center of a sidewall of the connector housing 3.

As shown in FIGS. 2B, 2D and 2E, the nut-storing-section 3d formed in the locking section 3C is a cylindrical recess having a rectangular section, which is opened at an upper side and elongated vertically, and formed in a depth at which a sideways hexagon-nut is fully received. The nut-storing-section 3d has a width in a back and forth direction, which is corresponding to thickness of the nut to be stored but slightly larger than the thickness.

In the locking section 3c, a screw-insertion-hole 3e is formed, which runs through the locking section 3c in a back and forth direction across the nut-storing-section 3d. Moreover, a shell-strip through-hole 3f is formed above the screw insertion hole 3e, which runs through the locking section 3c in the back and forth direction. Furthermore, a pair of bosses 3g is projected from each of back and bottom sides of the connector housing 3, the bosses being for positioning when the electric connector receptade 1 is mounted on the printed circuit board.

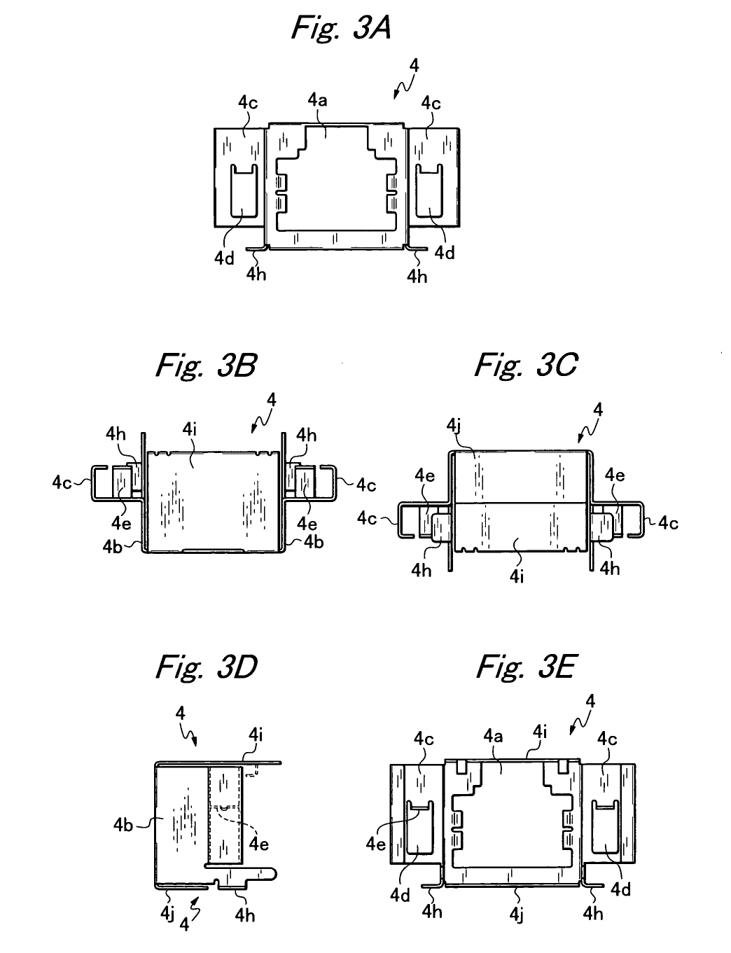

On the other hand, as shown in FIGS. 3A to 3E, the metal shell 4 covers the connector housing 3 approximately wholly as the measure against EMI as shown in FIG. 1, and for example, is made of stainless steel, wherein a punch-out hole 4a corresponding to a fitting-in shape of the fitting-in space 3a is formed in a central portion, and locking-section-cover 4c for covering the locking section 3c having the nut-storing-section 3d is formed in either lateral portion. The locking section cover 4c is folded along the locking section 3c from a sidewall portion 4b covering the sidewall of the connector housing 3 leaving a lower end portion (refer to FIGS. 3B and 3C).

A hole 4d for screw insertion is formed in a position corresponding to the screw-insertion-hole 3e at a front side of the locking section cover 4c. The hole 4d is formed in a vertically long, rectangular shape in such a cut-and-raise form that a strip of the shell is folded rearward with an upper edge as an axis, and the cut-and-raised shell strip is formed as a retaining through-strip 4e to be inserted into the shell-strip through-hole 3f. The retaining through-strip 4e is inserted into the shell-strip through-hole 3f and contacted to an upper part of the nut 2 stored in the nut-storing-section 3d, thereby prevents falling off of the nut and electrically conducts to the nut.

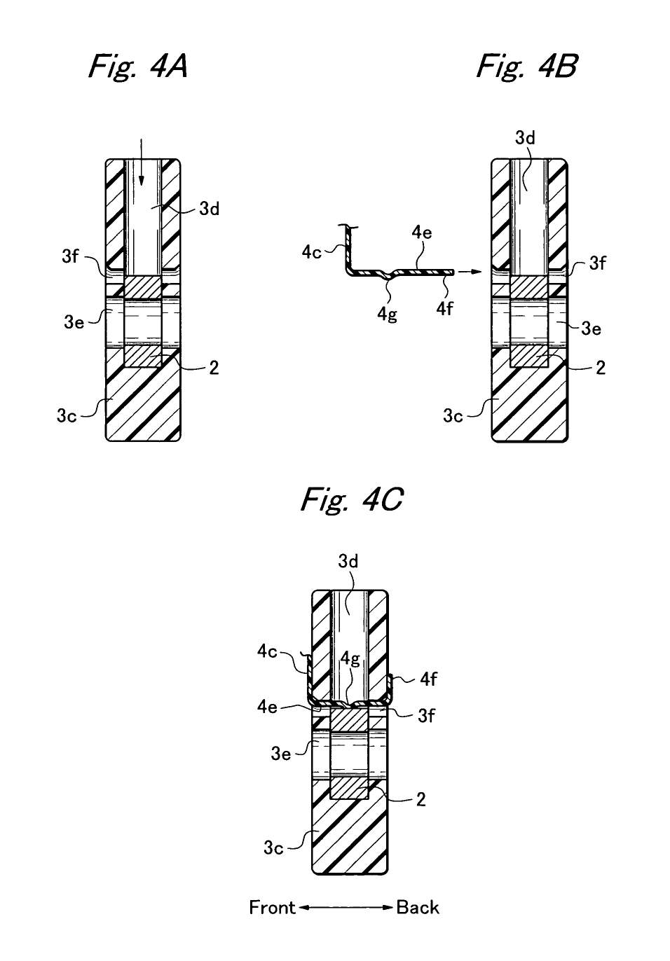

In the retaining through-strip 4e, as shown in FIGS. 4B and 4C, a latching strip 4f is formed in a front end portion of the strip 4e, which runs through the shell-strip through-hole 3f, and is bent in an upward or a downward, vertical direction to fix the shell 4 to the connector housing 3. Furthermore, a projection 4g for pressing the nut 2 downward is formed in approximately the center of the retaining through-strip 4e.

An attachment strip 4h for fixing the shell to the printed circuit board and grounding the shell is provided in the rear of a lower end of the sidewall portion 4b of the shell 4 in a manner of being bent sideward. A top board 4i and a bottom board 4j are provided on a top and a bottom of the metal shell 4 respectively. In the metal shell 4 formed in this way, after the connector housing 3 is inserted into the shell from the front, a part of the shell including the latching strip 4f is vertically bent for retaining at the back side.

In the locking section 3c, as shown in FIG. 4A, before the metal shell 4 is attached to the connector housing 3, the nut 2 is dropped into the nut-storing-section 3d from an opening at an upper side of the section. Then as shown in FIG. 4B, the retaining through-strip 4e of the metal shell 4 is inserted into the shell-strip through-hole 3f from a front side to a back side, and then the latching strip 4f as a protruded portion of the strip 4e is bent upward (refer to FIG. 4C). In this way, the retaining through-strip 4e of the metal shell 4 is fixed to the locking section 3c and thus falling-out of the nut 2 is prevented, and since the projection 4g of the retaining strip 4e presses the nut 2 downward, the nut 2 is fixed in the nut-storing-section 3d without rattling, in addition, stable electric conduction is achieved between the relevant nut 2 and the shell 4.

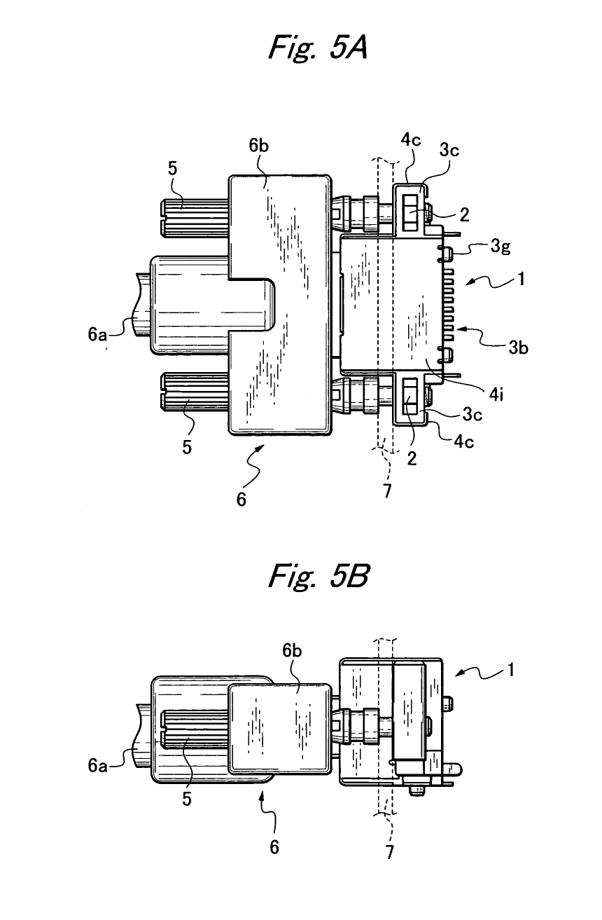

As shown in FIGS. 5A and 5B, the electric connector receptacle 1 configured in this way is fixed to a panel 7 of an electronic device and the like, and connected with a connector plug 6 having a screw 5 on either side. Ground for electric shield of a cable 6a of the connector plug 6 is conducted to a metal shell 6b for the plug 6, and when the electric connector receptacle 1 is connected to the connector plug 6, the metal shell 4 and the metal shell 6b are conducted and thus earthed to the ground of the printed circuit board at a side of the electric connector receptacle 1.

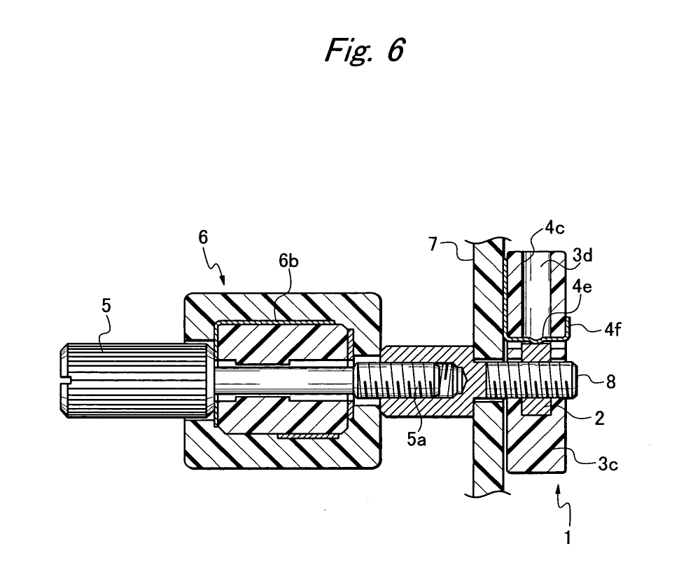

In addition to such an earth course between the metal shells 4 and 6, as shown in FIG. 6, the metal shell 6b for the connector plug 6 and the locked screw 5 are contacted and thus conducted. Then, a male screw portion 5a of the screw is conducted to an offset screw 8 for the panel 7 and the nut 2 at the side of the electric connector receptade 1 in turn via the screw 5. Furthermore, an earth course is formed, along which the nut 2 is conducted to the retaining through-strip 4e, and then the metal shell 4 is earthed to the ground of the printed circuit board on which the relevant electric connector receptacle 1 is mounted. In this earth course, the screw 5 and the nut 2 are fastened, thereby an electrical conduction channel firmly secured, leading to excellent durability.

1. An electric connector receptacle with lock nut comprising,
a connector housing having a pair of locking sections in which nut-storing-sections are formed,
nuts for locking by fitting-in stored in the nut-storing-sections, and
a metal shell that covers part of an outer surface of the connector housing;
wherein the nut-storing-section is opened at an upper side, and formed in a vertically elongated, concave shape with a depth at which the nut is fully received, and has a screw-insertion-hole running through the locking section in a back and forth direction across the nut-storing-section, and a shell-strip through-hole running through the locking section above the screw-insertion-hole and in the back-and-forth direction across the nut-storing-section,
and a retaining through-strip is formed in the shell, which is inserted into the shell-strip through-hole and contacted to an upper part of the nut stored in the nut-storing-section, thereby prevents falling-off of the nut, in addition, electrically conducts to the nut.

2. An electric connector receptacle with lock nut according to claim 1,
wherein a latching strip is extendedly provided at a front end of the retaining through-strip, which runs through the shell-strip through-hole and is bent in a vertical direction to fix the shell to the connector housing.

3. An electric connector receptacle with lock nut according to claim 1,
wherein a projection for pressing the nut is formed on a bottom side of the retaining through-strip.

4. An electric connector receptacle with lock nut according to claim 2,
wherein a projection for pressing the nut is formed on a bottom side of the retaining through-strip.
